(19) United States
(12) Patent Application Publication
(10) Pub. No.: US 2010/0325527 A1
(43) Pub. Date: Dec. 23, 2010

(54) OVERLAY FOR DIGITAL ANNOTATIONS

(75) Inventors: Julio Estrada, Medina, WA (US); Mohsen Agsen, Honolulu, HI (US); Yasser Asmi, Redmond, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/486,959

(22) Filed: Jun. 18, 2009

(51) Int. Cl. G06F 17/21

(52) U.S. Cl. 715/230

(57) ABSTRACT

A user input is received as a digital annotation, and the digital annotation is maintained as at least part of an overlay layer. The digital annotation is displayed, and if information from a program is being displayed then the digital annotation is displayed concurrently with the information from the program. Interaction between the overlay layer and the application layer can also be allowed.

### BACKGROUND

Computers have become increasingly commonplace, and can be found being used in a variety of different manners, such as surfing the Web, running of different applications, and so forth. A variety of different information can be displayed to users via such applications, such as articles, books, news items, documents, images, and so forth. Situations can arise where it would be desirable for users to make notes regarding the information that is being displayed to them. Unfortunately, computers do not currently provide an easy and uniform way for users to take notes or make sketches in such situations, which can lead to annoyance and frustration for the users.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In accordance with one or more aspects, a user input is received as a digital annotation, and the digital annotation is maintained as at least part of an overlay layer. The digital annotation is displayed concurrently with information in an application layer displayed by a program. Additionally, interaction between the overlay layer and the application layer is allowed.

In accordance with one or more aspects, user inputs are received as a digital annotation. The digital annotation is maintained as at least part of an overlay layer. The digital annotation is displayed, and if information from a program is being displayed then the digital annotation is displayed concurrently with the information from the program.

### BRIEF DESCRIPTION OF THE DRAWINGS

The same numbers are used throughout the drawings to reference like features.

FIG. 1 illustrates an example computing device implementing the overlay for digital annotations in accordance with one or more embodiments.

FIG. 2 is a block diagram illustrating an example of the architecture of a computing device in accordance with one or more embodiments.

FIGS. 3 and 4 illustrate an example of adding a digital annotation to information being displayed in accordance with one or more embodiments.

FIG. 5 is a flowchart illustrating an example process for a device implementing the overlay for digital annotations in accordance with one or more embodiments.

FIG. 6 illustrates an example computing device that can be configured to implement the overlay for digital annotations in accordance with one or more embodiments.

### DETAILED DESCRIPTION

An overlay for digital annotations is discussed herein. Generally, components and modules of a computing device execute in multiple different layers. An overlay layer executes as a layer above an application layer. A user is able to add notes or other digital annotations to the overlay, and have those notes or annotations maintained as being associated with the underlying information being displayed by the application in the application layer. The overlay allows the user to enter digital annotations regardless of which application is running (and even if no application is running), as well as regardless of what information is being displayed by the application that is running.

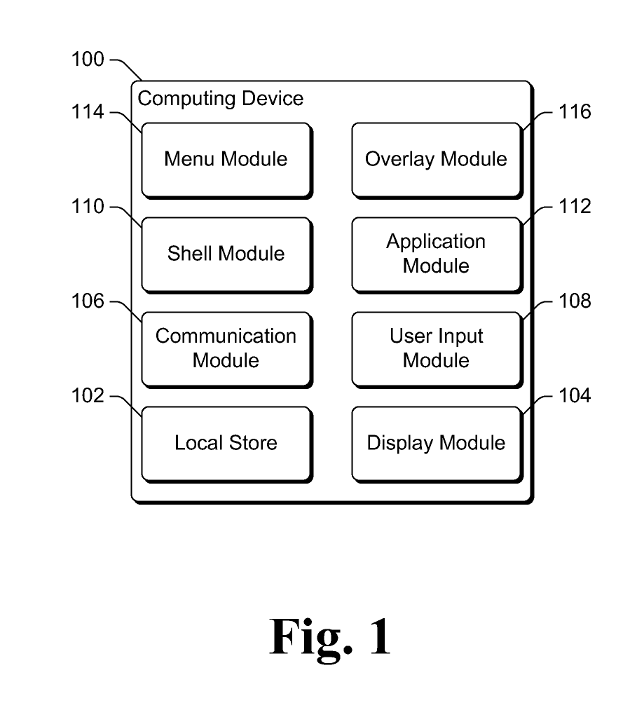

FIG. 1 illustrates an example computing device 100 implementing the overlay for digital annotations in accordance with one or more embodiments. Computing device 100 can be a variety of different devices capable of running applications. For example, computing device 100 can be a digital notepad, a dedicated digital book display device, a desktop computer, a mobile station, a netbook, an entertainment appliance, a set-top box communicatively coupled to a display device, a cellular or wireless phone, a game console, an automotive computer, and so forth. Thus, computing device 100 may range from a full resource device with substantial memory and processor resources (e.g., personal computers, game consoles) to a low-resource device with limited memory and/or processing resources (e.g., traditional set-top boxes, hand-held game consoles).

Computing device 100 includes a local store 102, a display module 104, a communication module 106, a user input module 108, a shell module 110, an application module 112, a menu module 114, and an overlay module 116. Each of modules 104-116 can be implemented in software, firmware, hardware, or combinations thereof. When implemented in software or firmware, a module includes one or more instructions that are executed by one or more processors or controllers of computing device 100.

Local store 102 provides local storage of instructions and/or data. Various instructions and data for different modules can be stored in local store 102. Additionally, data for annotations that are entered by a user can be stored in local store 102, as discussed in more detail below. Local store 102 can be implemented in a variety of different manners, such as using a magnetic disk, an optical disc, solid state devices (e.g., Flash memory), combinations thereof, and so forth. Local store 102 can be implemented as a fixed storage device that is part of computing device 100, and/or can be implemented as a removable storage device that is coupled to computing device 100. A removable storage device can be coupled to computing device 100 using a variety of different techniques, such as a Universal Serial Bus (USB) connection, a Wireless USB connection, an IEEE 1394 connection, an infrared connection, and so forth.

Display module 104 manages the display of information by computing device 100. The particular information displayed is generated by other modules or components of computing device 100. Computing device 100 can include display components via which such information is displayed, or alternatively computing device 100 can output signals to one or more other components or devices which in turn can display the information. The information can be displayed on any type of television, monitor, liquid crystal display (LCD), projector, or other display system that renders image data.

Communication module 106 manages communication with one or more services or devices, which can be situated remotely from or locally to computing device 100. Communication module 106 allows information to be displayed and/or otherwise used by modules 104-114 to be obtained from other services or devices. Communication module 106 can communicate with the services or devices in a variety of different manners, such as via the Internet, a local area network (LAN), a public telephone network, an intranet, other public and/or proprietary networks, a USB connection, a Wireless USB connection, an IEEE 1394 connection, an infrared connection, combinations thereof, and so forth. Communication module 106 can also communicate with local services or devices, such as via a Wireless USB connection, an infrared connection, and so forth.

User input module 108 allows user inputs or requests to be received by computing device 100. A variety of different digital annotations can be input via module 108, including written notes, images copied from other sources, and so forth. User input module 108 supports an ink input mechanism that allows the user to write notes or draw his or her inputs and have those written notes or drawings displayed on a screen of device 100. The display of such written notes or drawings is also referred to as ink due to its appearance being as if the user had handwritten the notes or drawings on a piece of paper. An ink input can be provided by the user in a variety of different manners, such as using a stylus, using his or her finger, using a touchpad, and so forth. The ink input can be a digital annotation for data being displayed by computing device 100, as discussed in more detail below.

User input module 108 can also support a variety of other types of input techniques, such as the selection of one or more physical buttons or keys of device 100, selection of one or more buttons displayed via a screen of device 100 (e.g., selected via a touchscreen), a particular input via a touchscreen (or touchpad) of device 100 (e.g., a single tap of the touchscreen, tapping the touchscreen twice in quick succession, inputting a particular symbol such as an “X” on the touchscreen, etc.), a particular physical feedback input to the device (e.g., tapping any portion of device 100 or another action that can be recognized by a motion detection component of device 100, such as shaking a device, rotating a device having a gyroscope, etc.), voice commands, and so forth.

Shell module 110 provides a base layer for a user interface (UI) of computing device 100. This base layer can also be referred to as, for example, a desktop. Shell module 110 can receive data and requests via user input module 108 or from other components or modules, and acts on such data and requests. Such data or requests can include, for example, requests to run an application, a digital annotation, and so forth.

Application module 112 is a software program that can be run on computing device 100. Although a single application module 112 is illustrated in FIG. 1, it is to be appreciated that multiple application modules can be included in computing device 100. A variety of different programs providing a variety of different functionality can be included as an application module 112, such as word processing programs, spreadsheet programs, reference programs, game programs, utility programs, Web browser programs, and so forth. Computing device 100 can also optionally provide a digital notebook or digital book functionality as an application module 112, or alternatively as part of another component or module (e.g., as part of shell module 110).

Menu module 114 provides additional UI functionality for other modules in computing device 100. Various menus, on-screen keyboards, ink types (e.g., ink displayed in different manners), and so forth. This UI functionality can be invoked by shell module 110 as well as application module 112. In one or more embodiments, application module 112 invokes this UI functionality by invoking an Application Programming Interface (API) of shell module 110, which in turn invokes the UI functionality of menu module 114. Alternatively, application module 112 can invoke the UI functionality of menu module 114 directly, and independently of shell module 110.

Overlay module 116 supports digital annotations for other modules of computing device 100. A user input in the form of a digital annotation (e.g., a written note, an image copied from another source, etc.) can be received by overlay module 116 via user input module 108. This user input is stored by overlay module 116 as a digital annotation. Overlay module 116 communicates with display module 104 to have the user inputs displayed, overlaying other data or information displayed by display module 104. Accordingly, the user can input digital annotations over any other data or information displayed by another module (e.g., an application module 112, a shell module 110, and so forth). Additionally, overlay module 116 communicates with shell module 110 to have the user inputs stored in local store 102.

Additionally, digital annotations can be received by overlay module 116 even if no application module 112 is running and/or no information is being displayed by an application module 112. Such digital annotations can be stored and displayed, effectively providing a digital notebook allowing the user to enter his or her digital annotations. Overlay module 116 can communicate with display module 104 to have such digital annotations stored, and with shell module 110 to have such digital annotations stored in local store 102.

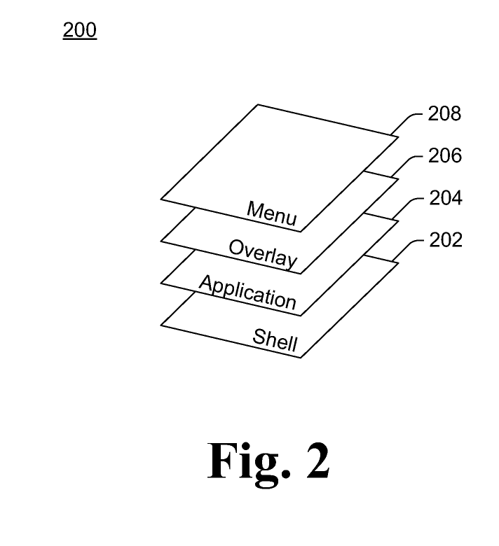

FIG. 2 is a block diagram illustrating an example of the architecture of a computing device in accordance with one or more embodiments. Architecture 200 of FIG. 2 is an example of a software and/or firmware architecture involving multiple layers 202, 204, 206, and 208. The layers 202-208 are illustrated as being on top of one another.

Shell layer 202 is the bottom layer and is implemented by, for example, shell module 110 of FIG. 1. Shell layer 202 provides a base layer for a UI of the computing device, and can also be a point from which one or more software programs can be run.

Application layer 204 is implemented by, for example, application module 112 of FIG. 1. A variety of different software programs or components can be run at application layer 204.

Overlay layer 206 is implemented by, for example, overlay module 116 of FIG. 1. Overlay layer 206 allows digital annotations to be input by a user for the software programs or components running in application layer 204 as well as shell layer 202.

Menu layer 208 is implemented by, for example, menu module 114 of FIG. 1. Menu layer 208 provides various common UI controls that can be invoked by software programs or components running in application layer 204 and/or by shell layer 202.

Information displayed by layers 202 or 204 can be annotated by the user adding a digital annotation to overlay layer 206. The displays provided by layers 202 or 204 can be referred to as being at one display level, while the digital annotations can be referred to as being at another display level. These multiple display levels can be combined, and the resultant combination displayed to the user as a single screen. Higher levels (e.g., the level displaying overlay layer 206) can be at least partially transparent, with information displayed in lower levels (e.g., provided by layers 202 or 204) being visible through the higher levels. In situations where information is present in both the higher and lower levels, the levels can be combined in a variety of different manners. For example, information in higher levels can be displayed at least partially transparently, allowing information from the different at the same display locations to be displayed concurrently. By way of another example, information in higher levels can be displayed opaquely, so that information (e.g., a digital annotation) from a higher level is displayed rather than information from a lower level.

Architecture 200 illustrates four different layers. In alternate embodiments, one or more additional layers can be added to architecture 200. For example a paper layer can be added between application layer 204 and shell layer 202. Such a paper layer can provide various functionality, such as providing a background for applications in application layer 204, providing common UI controls to be used across multiple applications in application layer 204, and so forth. Such additional layers can be provided by one of modules 110-116 of FIG. 1, or alternatively provided by an additional module of a computing device.

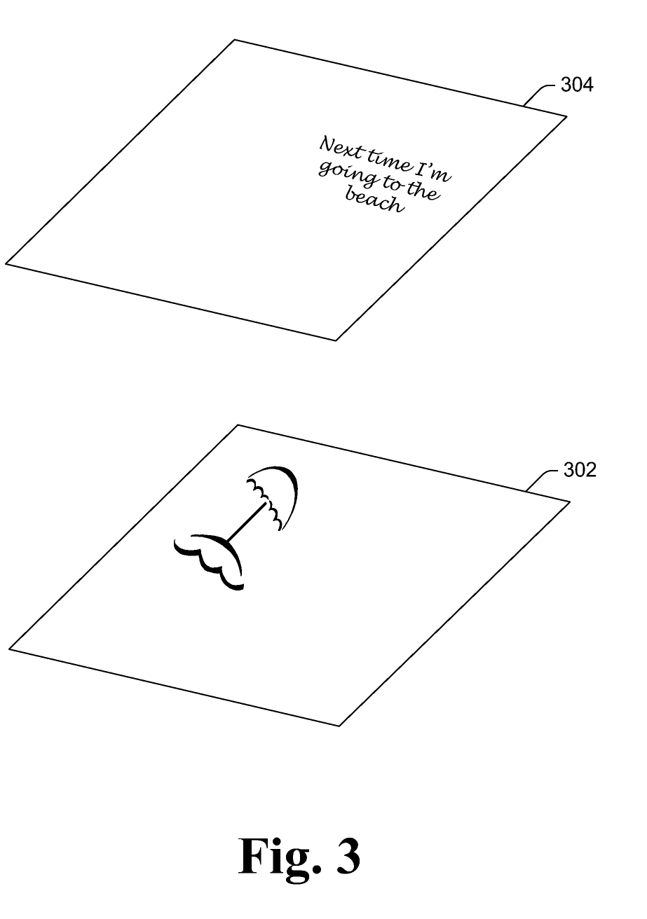

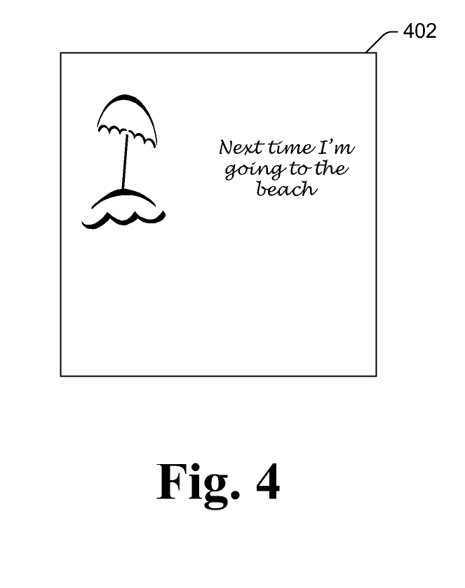

FIGS. 3 and 4 illustrate an example of adding a digital annotation to information being displayed in accordance with one or more embodiments. FIG. 3 illustrates two example layers 302 and 304. Assume that a Web browser (or other application) is running, displaying an image of a beach scene as shown in layer 302. Layer 302 is a display level provided by, for example, a program or component in application layer 204 of FIG. 2. Further assume that the user desires to add a digital annotation to that beach scene image, with the written note of “Next time I'm going to the beach”. The digital annotation is added to an annotation layer 304 that is a display level provided by, for example, overlay layer 206 of FIG. 2.

As illustrated in FIG. 3, the annotation is provided at a different level or layer than the information being annotated. The Web page or other information being displayed is not altered by the annotation that is added. Rather, the two are maintained separately.

Although the two are maintained separately, this separation is typically not visible to a user. Rather, the different layers are displayed together. FIG. 4 illustrates an example display 402 that is displayed to the user. As the user enters his or her annotation, it is displayed to the user as if it is being written on top of the Web page or other information being displayed. Accordingly, the user sees both the beach scene image and the annotation of “Next time I'm going to the beach”.

Returning to FIG. 1, during operation shell module 110 invokes menu module 114 and overlay module 116. Shell module 110 also provides an API that allows application module 112 to access functionality of menu module 114 and/or overlay module 116. During operation, a user can input control requests for shell module 110 or application module 112, and can also input digital annotations. In one or more embodiments, two different input modes are supported by computing device 100. The first input mode is a control input mode in which the user can input requests for shell module 110 or application module 112. The second input mode is a digital annotation input mode in which the user can input digital annotations. A user can request to switch between these two modes in a variety of different manners using a variety of different user inputs as discussed above.

Application module 112 can display information to users, as well as make certain UI controls available. Application module 112 displays information in the form of pages. In some situations a full page can be displayed by display module 104 at a time, or alternatively a portion of a page can be displayed at a time and the user is able to scroll the page to view different portions of the page.

Application module 112 also registers with shell module 110 for particular events. These events include user input events, such as user selection of a menu option, user input of data, user selection of a particular screen location, and so forth. When such events occur, shell module 110 notifies application module 112 of the particular event, such as a particular menu item that was selected, particular data that was input, a particular screen location that was selected, and so forth. Application module 112 can then act on those events in an appropriate manner based on the particular event and the manner in which module 112 is designed to respond to that particular event.

Overlay module 116 supports digital annotations for computing device 100. Digital annotations can be made over a display from an application module 112 or a display from shell module 110. This support for digital annotations includes receiving the digital annotation, maintaining the digital annotation, and displaying the digital annotation. This receiving, maintaining, and displaying is also performed with assistance from other modules, such as user input module 108, shell module 110, and display module 104.

A digital annotation refers to content input by a user, including content that is associated with information displayed by another module as well as content that is independent of information displayed by other modules. This content can include written notes such as various characters (e.g., letters, numbers, symbols, etc.), drawings, and so forth. This content can also include images copied from other sources (e.g., being displayed by other modules). For example, a user can input a request to select information being displayed by application module 112 and have that information copied and added (e.g., “pasted”) to the overlay layer as an annotation.

When the user inputs a digital annotation, the digital annotation is saved by overlay module 116. Both the data of the digital annotation (e.g., the written note or drawing, the copied image, etc.) and the location of that data on the display is saved as part of (and/or otherwise associated with) the digital annotation. Overlay module 116 communicates with shell module 110 to have the digital annotation saved in local store 102. In addition, if information is being displayed by application module 112, then a current image of the information displayed by application module 112 is also saved. The specific information displayed can vary based on the particular application module 112, and can be, for example, a Web page, other text, other images, and so forth. Overlay module 116 sends a request to save this current image to, for example, shell module 110 or application module 112. In response, the current image is saved by module 110 or module 112.

It is to be appreciated that, as application module 112 runs, the information displayed by module 112 can change. To account for such changes, the current image of the information displayed by module 112 is saved. The digital annotation that is entered by the user is also saved as being associated with this current image, and thus is also associated with this module 112. This association can be maintained in a variety of manners, such as by storing the digital annotation and the image in a same file or folder, maintaining a record of an identifier of the digital annotation corresponding to an identifier of the image, and so forth. Various other information regarding the digital annotation can also be saved, such as a date and/or time the digital annotation was entered.

In one or more embodiments, the digital annotation is saved by overlay module 116 in response to a save request being input by the user. For example, a variety of different user inputs as discussed above can be used by the user to request that the digital annotation be saved. Alternatively, digital annotations can be saved automatically by module 116. For example, after input of a digital annotation begins, the digital annotation can be automatically saved after a threshold amount of time passes with no additional input. By way of another example, overlay module 116 can be notified by application module 112 (e.g., via shell module 110 as discussed in more detail below) when the information being displayed by module 112 changes. In response, the digital annotation can be automatically saved as being associated with the information being displayed by module 112 before the change in display.

Accordingly, a user can subsequently request that digital annotations he or she previously input be displayed. Specific digital annotations can be requested by the user in a variety of different manners, such as digital annotations associated with a particular application module 112, digital annotations entered at a particular date and/or time, a list of stored digital annotations can be displayed to the user and the user can select a digital annotation from the list, and so forth. Multiple digital annotations can optionally be input and/or displayed concurrently by overlay module 116.

In one or more embodiments, shell module 110 exposes an API allowing interaction between overlay module 116 and application module 112. This interaction can also be referred to as interaction between the overlay layer provided by overlay module 116 (e.g., overlay layer 206 of FIG. 2) and the application layer provided by application module 112 (e.g., application layer 204 of FIG. 2). This interaction can include application module 112 requesting digital annotations from overlay module 116, and/or application module 112 requesting manipulation of digital annotations by overlay module 116. Shell module 110 essentially operates as a broker, allowing commands and/or information to be passed between modules 116 and 112.

In one or more embodiments, application module 112 can poll overlay module 116 for digital annotations added to a particular region or regions of the display. A region of the display refers to one or more locations of the display. In response to such a polling request, overlay module 116 checks whether one or more digital annotations are present in the identified region or regions. If present, then the one or more digital annotations are returned to application module 112.

Alternatively, rather than polling overlay module 116, application module 112 can register for notification of changes to digital annotations in a specific region or regions of the display. Shell module 110 or overlay module 116 can maintain a record of the region or regions that module 112 has registered for. When a digital annotation is added to that region or regions, shell module 110 or overlay module 116 notifies application module 112 of the one or more digital annotations that have been added to the region or regions.

It should be noted that with the different layers, a digital annotation is not constrained to existing in a particular location specified by application module 112. For example, an input field (e.g., a signature box) can be displayed by application module 112, and a user can enter his or her signature as a digital annotation. When the user adds his or her signature as a digital annotation, then the digital annotation is obtained by application module 112 (e.g., using polling or notification as discussed above). This digital annotation, however, may or may not be contained within the area of the input field displayed by module 112 (e.g., the portions of the signature may extend beyond the field). Nonetheless, this entire digital annotation (e.g., the “whole” ink input by the user) can be saved and provided to module 112.

Additionally, in one or more embodiments application module 112 can send commands to overlay module 116 to manipulate one or more digital annotations being displayed by overlay module 116. This manipulation can be, for example, to change a location of an annotation, to change an appearance of an annotation (e.g., change a color of the digital annotation, change a transparency of the digital annotation, and so forth). In response to such a command, overlay module 116 manipulates the one or more digital annotations as requested.

This interaction between overlay module 116 and application module 112 allows application module 112 to have some input as to the digital annotations being displayed, and can be used to improve the display of the digital annotations. For example, application module 112 can identify locations of digital annotations that conflict with information being displayed by application module 112, and submit commands to overlay module 116 to move the digital annotations and/or change the appearance of the digital annotations so that the information displayed by module 112 and the digital annotations displayed by module 116 can be displayed harmoniously.

Overlay module 116 also supports various configuration options, allowing a user of computing device 100 to configure how digital annotations are displayed. The user can input such configuration options in a variety of different manners using various user inputs as discussed above. A variety of different display characteristics can be set using these configuration options. In one or more embodiments, pen characteristics can be set that allow a user to configure an appearance of notes written by the user. This appearance can also be referred to as the appearance of digital ink that is displayed as the digital annotation. These pen characteristics include, for example, the color of the ink, the width of the ink lines, and so forth. Other display characteristics can also be configuration options, such as a transparency level (e.g., indicating a transparency or opaqueness of digital annotations), whether digital annotations can be manipulated by application module 112, and so forth.

In one or more embodiments, overlay module 116 also supports an erase functionality. The erase functionality allows a user to erase or delete one or more digital annotations. The erase functionality can allow erasure of a group of digital annotations and/or selected digital annotations. For example, the user can input a request to erase all digital annotations being displayed. By way of another example, the user can select particular digital annotations by providing various user inputs (in a variety of different manners as discussed above).

Thus, as can be seen from the discussions above, the digital annotations can be added by users in a variety of different situations. Digital annotations can be added to information displayed by a variety of different applications, including Web browsers as well as other types of programs. The applications can be aware of the digital annotations and interact with the overlay layer, or can be unaware of the digital annotations and not interact with the overlay layer. Furthermore, digital annotations can be added to an overlay layer when no application is running on a lower application layer; rather, the digital annotations can be used to effectively create a digital notebook for the user.

Additionally, it is to be appreciated that the overlay layer is a separate layer and is implemented by a module that is separate from and independent of an application module that provides the application layer. Although the two can interact with one another as discussed above, operation of the overlay module providing the overlay layer is not conditioned on the operation of the application module providing the application layer. Accordingly, if the application module were to cease operating properly (e.g., the program at the application layer were to stop running properly), the overlay layer and digital annotations need not be affected due to their being independent from the application module.

Furthermore, as the overlay layer is implemented by a module separate from the other modules in computing device 100, the overlay layer can be run as a process at a higher priority than other processes (and thus have a higher priority than other modules). For example, the overlay layer can be run as a higher priority process than applications in the application layer. This higher priority status results in improved perceived responsiveness in handling digital annotations (e.g., allowing ink to be rendered before an application's content).

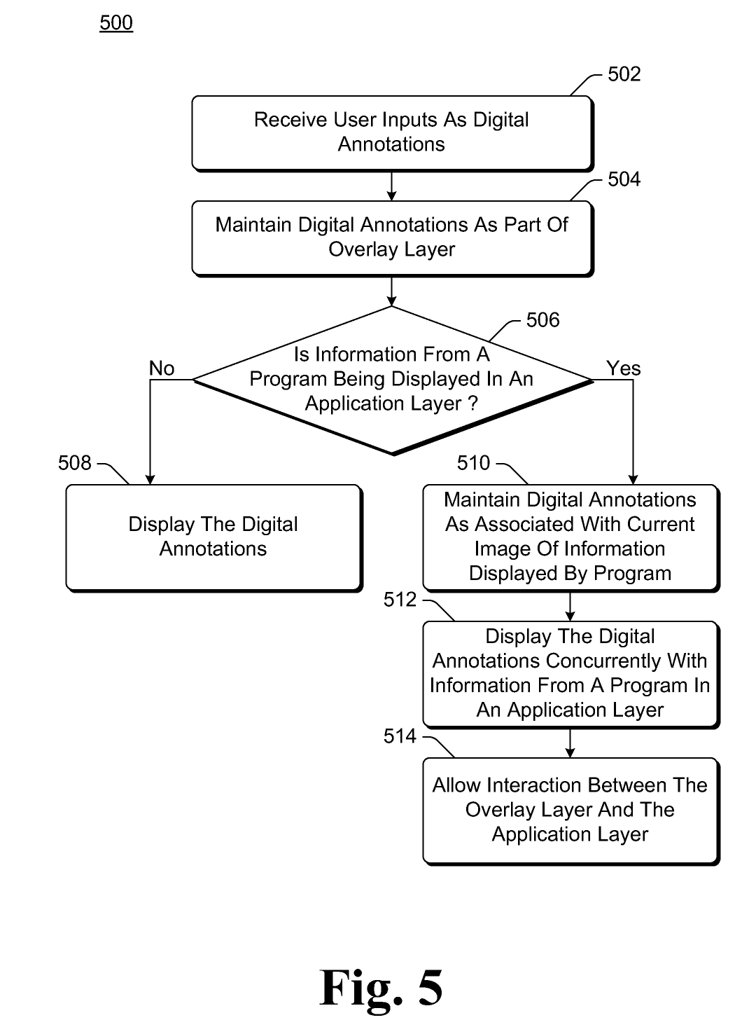

FIG. 5 is a flowchart illustrating an example process 500 for a device implementing the overlay for digital annotations in accordance with one or more embodiments. Process 500 is carried out by a device, such as computing device 100 of FIG. 1, and can be implemented in software, firmware, hardware, or combinations thereof. Process 500 is an example process for implementing the overlay for digital annotations; additional discussions of implementing the overlay for digital annotations are included herein with reference to different figures.

In process 500, user inputs are received as digital annotations (act 502). These digital annotations can take a variety of different forms, such as written notes or including various characters (e.g., letters, numbers, symbols, etc.), drawings, and so forth. This content can also include images copied from other sources, and so forth.

The digital annotations received in act 502 are maintained as part of an overlay layer (act 504). This overlay layer is provided by an overlay module that is independent of other application modules as discussed above.

Process 500 then proceeds based on whether information from a program is being displayed in an application layer (act 506). If information from a program is not being displayed in an application layer, then the digital annotations received in act 502 are displayed (act 508). These digital annotations allow the user to effectively create a digital notebook with the digital annotations as discussed above.

However, if information from a program is being displayed in an application layer, then the digital annotations received in act 502 are maintained as associated with a current image of information being displayed by the program (act 510). The digital annotations can be associated with the current image in a variety of different manners as discussed above.

The digital annotations are also displayed concurrently with the information from the program in the application layer (act 512). The overlay layer in which the digital annotations and the application layer in which the information from the program is displayed are displayed concurrently, as discussed above.

Additionally, interaction between the overlay layer and the application layer is allowed (act 514). This interaction can include, for example, the application requesting the digital annotations, and/or the application requesting manipulation of the digital annotations as discussed above.

The overlay for digital annotations discussed herein provides an overlay layer via which the user is able to add notes or other digital annotations. This overlay allows various usage scenarios and facilitates use of digital annotations. For example, the overlay for digital annotations can allow ink to flow anywhere on top of application content (e.g., Web pages, documents, etc.) unconstrained by application UI boundaries (e.g., input boxes in forms). The overlay can also allow applications to register interest in specific regions (e.g., a signature box) yet receive the “whole” ink (e.g., a complete signature) intersecting with the region of interest rather than just the portion that intersects the signature box.

Additionally, the overlay for digital annotations allows digital annotations to be handled (e.g., stored, rendered, analyzed, etc.) uniformly and separately from any individual application's logic. Accordingly, digital annotations can be handled uniformly across forms on the web, documents, books, and so forth.

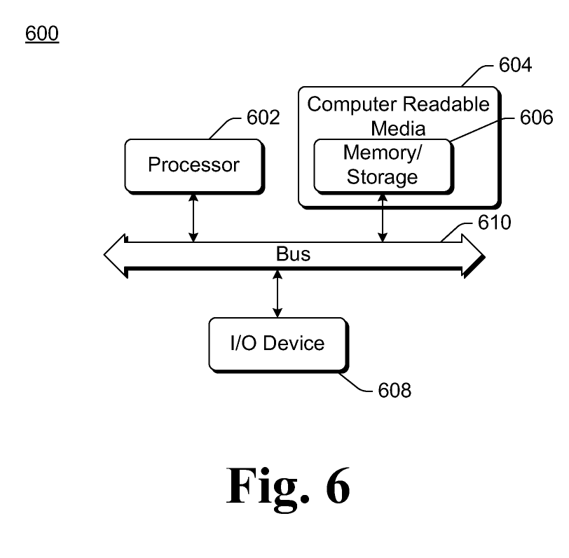

FIG. 6 illustrates an example computing device 600 that can be configured to implement the overlay for digital annotations in accordance with one or more embodiments. Computing device 600 can be, for example, computing device 100 of FIG. 1.

Computing device 600 includes one or more processors or processing units 602, one or more computer readable media 604 which can include one or more memory and/or storage components 606, one or more input/output (I/O) devices 608, and a bus 610 that allows the various components and devices to communicate with one another. Computer readable media 604 and/or one or more I/O devices 608 can be included as part of, or alternatively may be coupled to, computing device 600. Bus 610 represents one or more of several types of bus structures, including a memory bus or memory controller, a peripheral bus, an accelerated graphics port, a processor or local bus, and so forth using a variety of different bus architectures. Bus 610 can include wired and/or wireless buses.

Memory/storage component 606 represents one or more computer storage media. Component 606 can include volatile media (such as random access memory (RAM)) and/or nonvolatile media (such as read only memory (ROM), Flash memory, optical disks, magnetic disks, and so forth). Component 606 can include fixed media (e.g., RAM, ROM, a fixed hard drive, etc.) as well as removable media (e.g., a Flash memory drive, a removable hard drive, an optical disk, and so forth).

The techniques discussed herein can be implemented in software, with instructions being executed by one or more processing units 602. It is to be appreciated that different instructions can be stored in different components of computing device 600, such as in a processing unit 602, in various cache memories of a processing unit 602, in other cache memories of device 600 (not shown), on other computer readable media, and so forth. Additionally, it is to be appreciated that the location where instructions are stored in computing device 600 can change over time.

One or more input/output devices 608 allow a user to enter commands and information to computing device 600, and also allows information to be presented to the user and/or other components or devices. Examples of input devices include a keyboard, a cursor control device (e.g., a mouse), a microphone, a scanner, and so forth. Examples of output devices include a display device (e.g., a monitor or projector), speakers, a printer, a network card, and so forth.

Various techniques may be described herein in the general context of software or program modules. Generally, software includes routines, programs, objects, components, data structures, and so forth that perform particular tasks or implement particular abstract data types. An implementation of these modules and techniques may be stored on or transmitted across some form of computer readable media. Computer readable media can be any available medium or media that can be accessed by a computing device. By way of example, and not limitation, computer readable media may comprise “computer storage media” and “communications media.”

“Computer storage media” include volatile and non-volatile, removable and non-removable media implemented in any method or technology for storage of information such as computer readable instructions, data structures, program modules, or other data. Computer storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

“Communication media” typically embody computer readable instructions, data structures, program modules, or other data in a modulated data signal, such as carrier wave or other transport mechanism. Communication media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media. Combinations of any of the above are also included within the scope of computer readable media.

Generally, any of the functions or techniques described herein can be implemented using software, firmware, hardware (e.g., fixed logic circuitry), manual processing, or a combination of these implementations. The terms “module” and “component” as used herein generally represent software, firmware, hardware, or combinations thereof. In the case of a software implementation, the module or component represents program code that performs specified tasks when executed on a processor (e.g., CPU or CPUs). The program code can be stored in one or more computer readable memory devices, further description of which may be found with reference to FIG. 6. The features of the overlay for digital annotations techniques described herein are platform-independent, meaning that the techniques can be implemented on a variety of commercial computing platforms having a variety of processors.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. One or more computer storage media having stored thereon multiple instructions that, when executed by one or more processors of a device, cause the one or more processors to:
receive user input as a digital annotation;
maintain the digital annotation as at least part of an overlay layer;
display the digital annotation concurrently with information in an application layer displayed by a program; and
allow interaction between the overlay layer and the application layer.

2. One or more computer storage media as recited in claim 1, wherein the digital annotation includes a written note.

3. One or more computer storage media as recited in claim 1, wherein the digital annotation includes an image being displayed by the program.

4. One or more computer storage media as recited in claim 1, wherein the digital annotation includes both a written note and information copied from another source.

5. One or more computer storage media as recited in claim 1, the instructions further causing the one or more processors to save a current image of information being displayed by the program, and save the digital annotation as being associated with the current image.

6. One or more computer storage media as recited in claim 1, wherein the interaction comprises information from the overlay layer being passed to the program.

7. One or more computer storage media as recited in claim 1, wherein the interaction comprises the program manipulating the digital annotation being displayed in the overlay layer.

8. One or more computer storage media as recited in claim 1, wherein the overlay layer is provided by a module independent of the program.

9. One or more computer storage media as recited in claim 1, wherein the program comprises a Web browser, and the information in the application layer comprises a Web page.

10. One or more computer storage media as recited in claim 1, wherein the instructions further cause the one or more processors to receive, without the program running, information from an additional user input as an additional digital annotation.

11. A method implemented in a computing device, the method comprising:
receiving user inputs as a digital annotation;
maintaining the digital annotation as at least part of an overlay layer; and
displaying, if information from a program is being displayed, the digital annotation concurrently with the information from the program, otherwise displaying the digital annotation.

12. A method as recited in claim 11, wherein the digital annotation includes a written note.

13. A method as recited in claim 11, wherein the digital annotation includes an image copied from another source.

14. A method as recited in claim 13, wherein the image comprises an image being displayed by the program.

15. A method as recited in claim 11, further comprising, if information from the program is being displayed, saving a current image of the information being displayed by the program, and saving the digital annotation as being associated with the current image.

16. A method as recited in claim 11, further comprising, if information from the program is being displayed, then allowing interaction between an overlay module providing the overlay layer and the program.

17. A method as recited in claim 16, the allowing comprising allowing information from the overlay module to be passed to the program.

18. A method as recited in claim 16, the allowing comprising allowing the program to manipulate the digital annotation being displayed by the overlay module in the overlay layer.

19. A method as recited in claim 11, wherein if there is a program, then the overlay layer is provided by a separate module independent of the program.

20. One or more computer storage media having stored thereon multiple instructions that, when executed by one or more processors of a device, cause the one or more processors to:
receive user input as a digital annotation;
maintain the digital annotation as at least part of an overlay layer;
check whether information from a program is being displayed in an application layer;
if information from the program is not being displayed in the application layer, then display the digital annotation;
if information from the program is being displayed in the application layer, then:
save a current image of the information being displayed by the program and the digital annotation as being associated with the current image;
display the digital annotation concurrently with information in the application layer; and
allow interaction between the overlay layer and the application layer.
